(19) United States
(12) Patent Application Publication
(10) Pub. No.: US 2007/0115846 A1
(43) Pub. Date: May 24, 2007

(54) Method for controlling data throughput in a storage area network

(76) Inventors: Sheridan Kooyers, Star, ID (US); Dean S. Nelson, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,732

(22) Filed: Nov. 1, 2005

(51) Int. Cl. H04J 1/16

(52) U.S. Cl. 370/252; 370/465

(57) ABSTRACT

A method and system for controlling data throughput in a network connecting two sites in which mixed communication protocols are employed, and in which the inter-site communication protocol is different than the intra-site communication protocol. A series of PING source messages are sent from a source storage device to a destination storage device via a network link. PING response messages, from the destination storage device via the network link, indicating receipt of each of the PING source messages are received and sampled. Round trip PING times for each of the PING source messages and corresponding PING response messages are determined and then sorted to separate PING timing data sampled when the network link was idle from PING timing data sampled when the network link was in use. The difference between the sampled idle PING timing data and the sampled busy PING timing data is calculated to obtain a delta PING time. The number of transmission resources associated with the source storage device is then adjusted as a function of the value of the delta PING time and of a current inter-site transmission retry rate to reduce contention for transmission resources on the intra-site link.

### BACKGROUND

In a storage area network (SAN), data originating (or present) on one data storage site is often replicated on a different, remote data storage site. IP/SAN gateways are typically employed to transmit this data between Fibre Channel-based SAN sites over long distances. Bandwidth allocation and availability for these inter-site links is often limited and expensive. These interconnected IP/SAN gateways typically employ flow control protocols such as TCP or UDP between the gateways. However, the SAN storage sites using these gateways typically employ a Fibre Channel protocol which allows intra-site communication, e.g., between a server and a storage device, at a higher bandwidth than the IP/SAN gateway connecting the two SAN sites.

Furthermore, traditional flow control mechanisms such as TCP often break down as a result of network resource contention in mixed protocol environments. For example, in Fibre Channel-based storage area networks that employ SAN/IP gateways, Fibre Channel and TCP/IP data flow control incompatibility often results in the blocking of data transfers in an inter-site network path shared by more than one device. Therefore, the lower bandwidth inter-site path often appears to cause flow control problems in this mixed protocol environment.

Previous attempts to solve this compound problem of flow control and sub-optimal throughput between IP/SAN gateways included increasing the size of buffers used at the network gateways. However, increasing the gateway buffer size did not solve the problem, and in some instances actually resulted in decreased throughput between SAN sites. Since increasing the gateway buffer size was not effective in solving this problem, there apparently exists an underlying problem, the cause of which had not previously been identified.

Therefore, not only does the source of this problem of sub-optimal throughput between SAN sites need to be identified, but also an effective solution to the problem is required to allow maximizing the available bandwidth of the inter-site communications path, and also to prevent overloading of this relatively lower bandwidth connection.

### SUMMARY

A method and system is provided for controlling data throughput in a network connecting two sites in which the intra-site communication bandwidth is greater than the inter-site bandwidth. A series of PING source messages are sent from a source storage device to a destination storage device via a network link. PING response messages, from the destination storage device via the network link, indicating receipt of each of the PING source messages are received and sampled. Round trip PING times for each of the PING source messages and corresponding PING response messages are determined and then sorted to separate PING timing data sampled when the network link was idle from PING timing data sampled when the network link was in use.

The difference between the sampled idle PING timing data and the sampled busy PING timing data is calculated to obtain a delta PING time. The number of transmission resources associated with the source storage device is then adjusted as a function of the value of the delta PING time and the current inter-site transmission retry rate to reduce contention for transmission resources on the intra-site link.

### BRIEF DESCRIPTION OF THE DRAWINGS

FIG. 1 shows a prior art system for communication between two sites in a storage area network;

FIG. 2 is a diagram showing an exemplary embodiment of a storage area network employing the present method;

FIG. 3 is a flowchart showing an exemplary set of steps performed in one embodiment of the present method;

FIG. 4 is a flowchart showing an exemplary set of steps performed in step 360 of the embodiment depicted in FIG. 3;

FIG. 5 is a diagram showing an exemplary embodiment of a resource computation module; and

FIG. 6 is a flowchart showing an exemplary set of steps performed to determine the resource ramp-up rate for a storage device.

### DETAILED DESCRIPTION

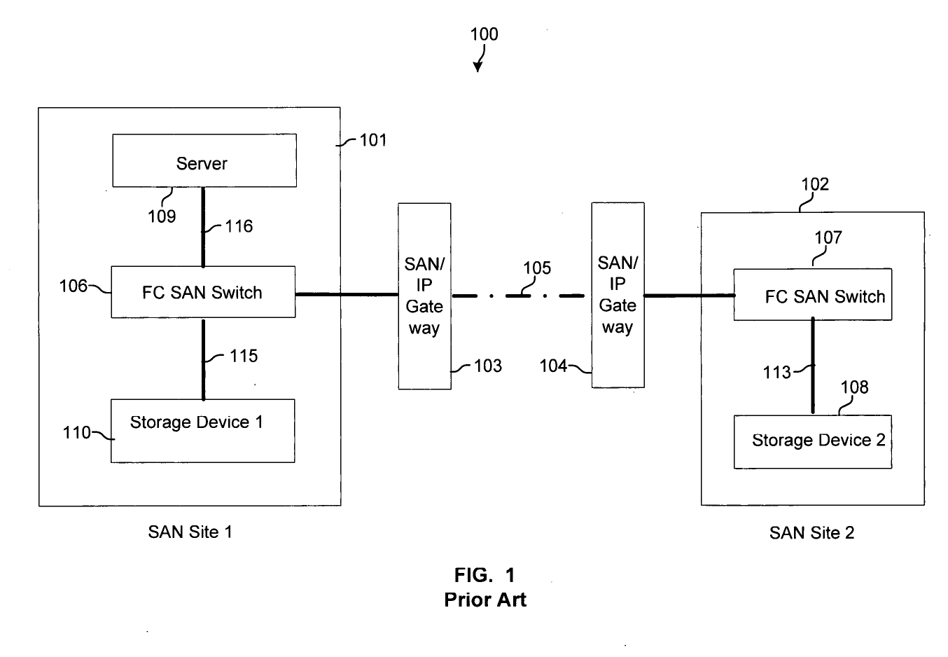

In a storage area network (SAN), data originating (or present) on one data storage site may be replicated on a different, remote data storage site. FIG. 1 shows a prior art storage area network 100 for communication between two sites 101/102 in the network. As shown in FIG. 1, SAN sites 101 and 102 each includes a Fibre Channel switch 106/107, and at least one data storage device 110/108, respectively. It is assumed herein that each SAN site 101/102 in SAN 100 normally employs a Fibre Channel-based protocol for intra-site communication (e.g., between storage device 110 and switch 106). Inter-site communication, such as between sites 101 and 102, utilizes IP/SAN gateways 103/104, which typically employ IP-based (Internet Protocol-based) network services, and a flow control protocol such as TCP or UDP, between the gateways. The IP/SAN gateways 103/104 typically employ proprietary methods for converting from Fibre Channel to TCP/IP and back to Fibre Channel, for communication between the gateways.

SAN site 101 also includes a server 109, connected to Fibre Channel switch 106 via link 116. Switch 106 is connected to storage device 110 via link 115, which shares traffic (transmitted data) between storage device 110 and switch 106, as well as traffic between the storage device 110 and IP/SAN gateway 103, via the switch 106. In a typical SAN environment, the bandwidth of link 115 is 2 Gbits/sec or higher. The flow of data between SAN sites 101/102 via inter-gateway communication link 105 is typically much slower, for example, 155 Mbits/sec

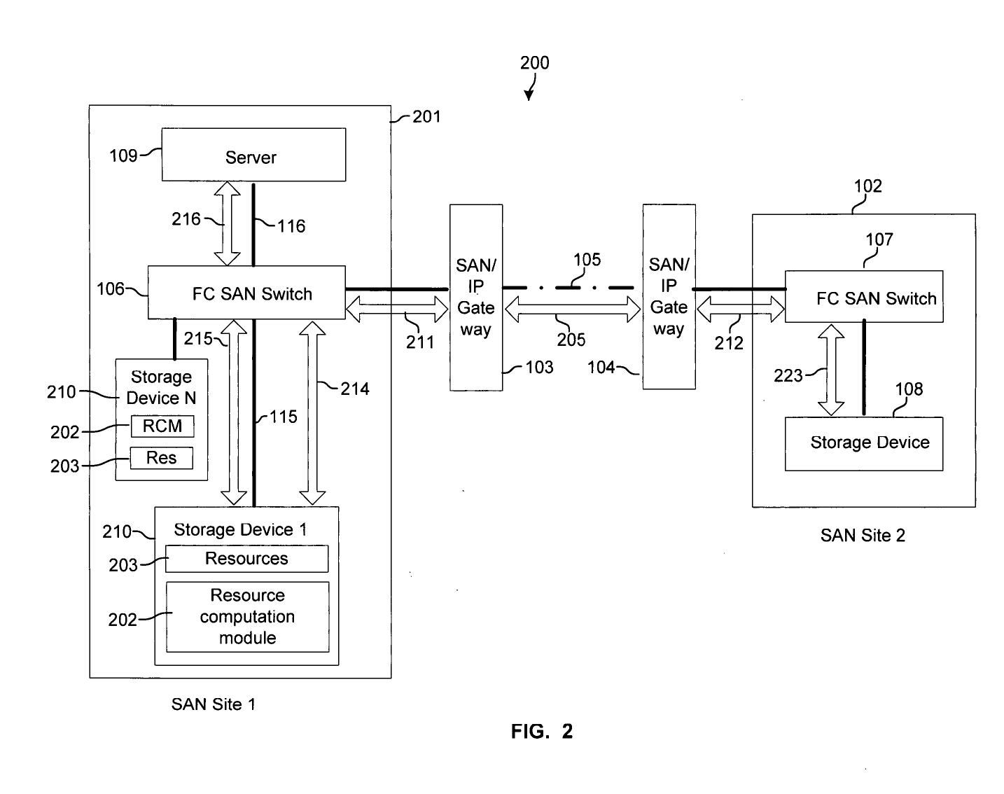

FIG. 2 is a diagram of an exemplary embodiment of a storage area network 200 employing the present method for controlling data throughput in the network. Although only two SAN sites 201/102 are shown in the storage area network of FIG. 2, the present method is operable with more than one local, or ‘source’ site 201, as well as multiple remote, or ‘destination’ sites in addition to site 102. In addition, each of the SAN sites in the network of system 200 may include devices in addition to the server 109, Fibre Channel switch 106, and storage device 210 shown in FIG. 2. As in FIG. 1, the system shown in FIG. 2 employs mixed protocols such as Fibre Channel and TCP/IP. However, the present method is not limited to SAN sites employing a Fibre Channel-based protocol, and it is to be noted that each source SAN site (e.g., site 201) may use an intra-site communications protocol other than Fibre Channel. Furthermore, in an alternative embodiment, the inter-site communication protocol and the intra-site communication protocol may both constitute the same protocol, with the inter-site link having a lower bandwidth than the intra-site link.

The present method controls the data throughput in a mixed protocol type of environment, and provides improved utilization of network bandwidth where there are significant differences between the data rates of incoming and outgoing signals at a gateway interface 103. As noted in the Background section, the primary source(s) of the problems of flow control and sub-optimal throughput between IP/SAN gateways had not been previously identified. The present method solves these problems by first identifying their source, which was determined to be overloading of the lower bandwidth interface at IP/SAN gateways 103/104, resulting in the blocking of data transmission between devices that share a common higher bandwidth path, such as link 115. Essentially, the problem identified in implementation of the present method is that an excessive amount of data transmitted over the low bandwidth path 105 will reduce the throughput of data transmitted over the higher bandwidth shared path 115. This reduction in the throughput of data over the shared path 115, in turn, has an adverse effect on the amount of data transmitted over the higher bandwidth path 116. Excessive low bandwidth data blocks the higher bandwidth data that needs to be transmitted between the storage device and the server via path 115/116.

Exemplary data transfer in system 200 is described as follows, as indicated by data flow arrows in FIG. 2. At SAN site 201, data transferred between server 109 and switch 106 flows via link 116, as indicated by arrow 216. This data flows between switch 106 and storage device 210 via link 115, shown by arrow 215. Data transfer between local storage device 210 and remote storage device 108, at SAN site 102, is indicated by arrows 214, 211, 205, 212, and 223. Note that data (shown by arrow 214) being transmitted from storage device 210 to IP/SAN gateway 103 shares link 115 with data (shown by arrow 215) flowing between switch 106 and storage device 210.

A system in accordance with the present method uses the round trip time of a ‘PING’ message and the message retry rate (between storage devices 210 and 108) to determine and adjust the number of resources 203 necessary to perform optimal transmission of data (via path 214) over the shared network path (e.g., link 115). This adjustment of resources prevents overloading of the lower bandwidth interface at IP/SAN gateways 103/104 and link 105. As used herein, the term “resource” (or “transmission resource”) refers to communication slots or buffers that are available to send messages out via a communication link. For example, if there are 64 available resources, then only 64 messages can be in transit between two storage devices, e.g., device 210 and device 108. The number of available resources 203 for a particular storage device 210 is implementation-specific and governed by the Fibre Channel standard.

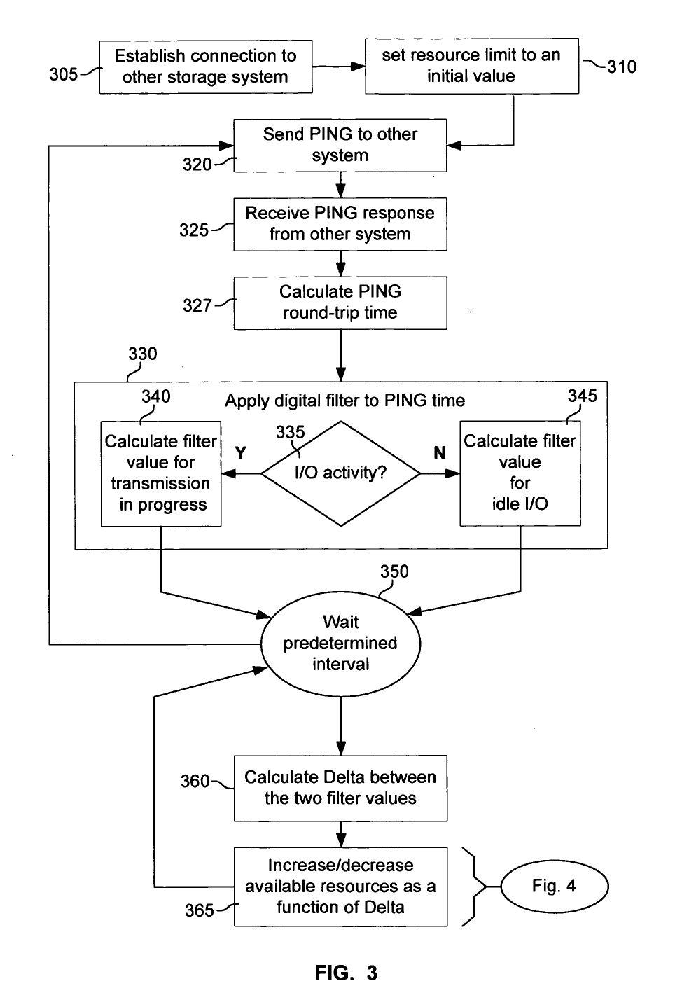

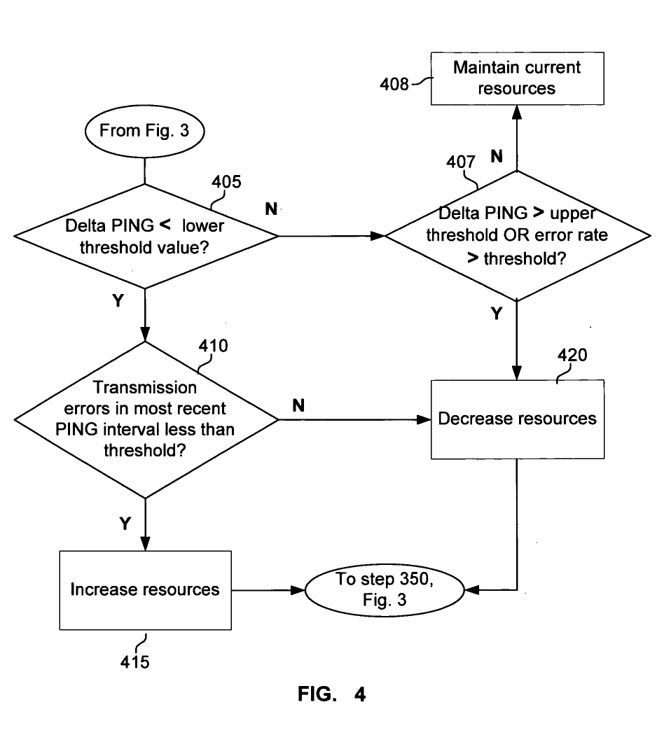

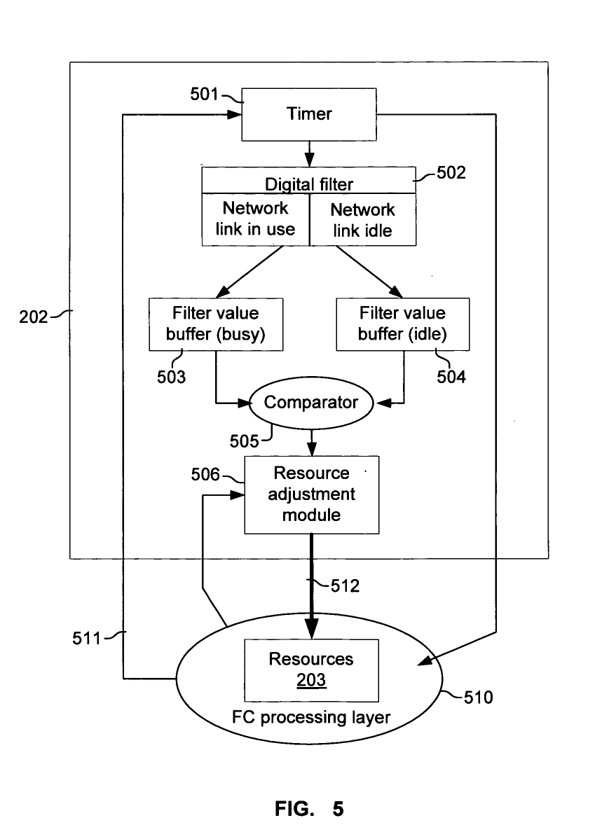

FIG. 3 is a flowchart showing an exemplary set of steps performed in one embodiment of the present method. As shown in FIG. 3, at step 305, a connection is established between a storage device (e.g., device 210) at local SAN site 201 and a storage device (e.g., device 108) at a remote SAN site 102. FIG. 3 is best described in conjunction with FIG. 5, which illustrates functional aspects of the given embodiment (FIG. 4 augments certain details shown in FIG. 3, and is described further below).

FIG. 5 is a functional block diagram showing an exemplary embodiment of a resource computation module 202, which performs the steps shown in FIG. 3, with the exception of steps 305, 320, and 325, which are performed by the Fibre Channel processing layer shown in block 510. Each storage device 210 performs the steps indicated in FIG. 3 only when a particular storage device is functioning as a source. That is, when data is being replicated from SAN site 1 (e.g., site 201) to SAN site 2 (e.g., site 102), steps 310 and 327 through 365 are performed by the source storage device 210 at SAN site 1. If, at a later time, SAN site 2 is set up to replicate data back to SAN site 1, then a storage device at SAN site 2 may invoke these steps.

In an exemplary embodiment, resource computation module 202 comprises software and/or firmware. An exemplary resource computation module 202 includes a timer 501, a digital filter 502, filter value buffers 503 and 504, comparator 505, and resource adjustment module 506.

In operation, timer 501 receives (‘samples’) a signal 511 from Fibre Channel processing layer 510 every time a PING response is received from a destination SAN site. The timer also sends a signal to the Fibre Channel processing layer to send a PING from the source SAN site (e.g., site 20) to a destination SAN site (e.g., site 102). Fibre Channel processing layer 510 is well known in the art, and functions in accordance with the Fibre Channel specification as defined by the ANSI working group X3T11. Timer 501 also determines the round-trip PING time for each PING sent from a local SAN site (e.g., SAN site 201) to, and back from, a remote SAN site (e.g., SAN site 102).

Digital filter 502 accepts input from timer 501, sorts the ‘system idle’ PING timing data from the ‘I/O in progress’ PING timing data, stores the PING timing data samples, and performs the filter calculations. Buffer 504 stores the result of the filter calculation when the inter-SAN network link 105 was idle (‘system idle’ data), and Buffer 503 stores the result of the filter calculation when the network link was in use (‘I/O in progress’ data).

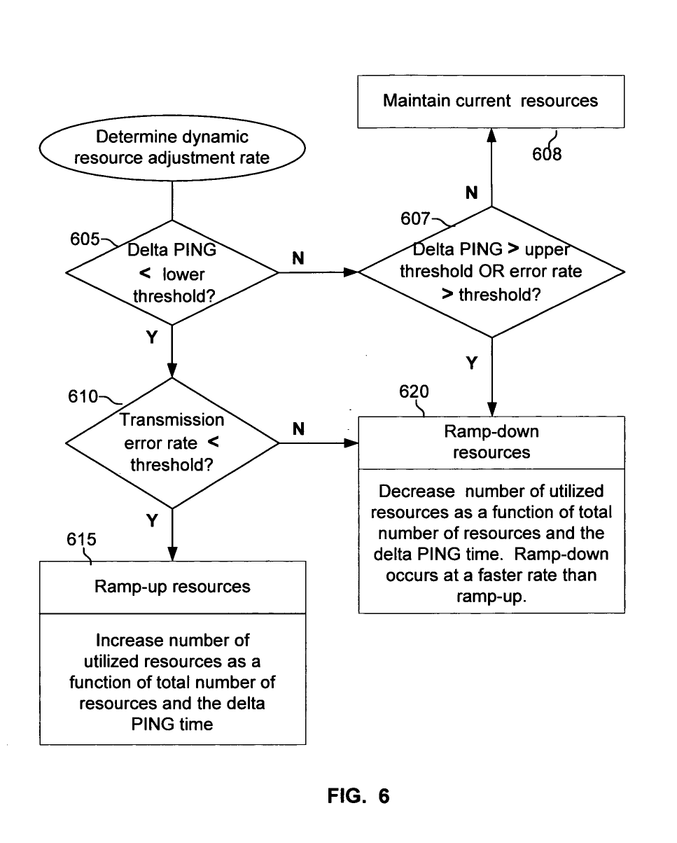

Comparator 505 determines the difference between the two filter values 503/504 (i.e., the difference between the system idle/busy round-trip PING times), and provides the resource adjustment module 506 with the resultant ‘delta PING time’. The number of resources 203 for a particular storage device 210 is then adjusted in accordance with parameters described below with respect to FIG. 4 and FIG. 6, as indicated by arrow 512.

As shown in FIG. 3, at step 310, the resource limit for the storage device of interest is set to an initial value, for example, 16 resources. At step 320, in an exemplary embodiment, short PING messages are sent at a predetermined interval, for example, once per second, between the source and destination devices (e.g., storage devices 210 and 108) that are communicating via lower bandwidth path 105. Other PING intervals could alternatively be employed. These PING messages are typically generated and received by the Fibre Channel processing layer 510, where all Fibre Channel messages are processed. The PING response is received back from the destination device, at step 325. The round trip time of the PING message is then determined, at step 327. The round trip PING time is sorted to separate PING timing data sampled when the network link 105 was idle from PING timing data sampled when the network link was in use, as shown in block 330.

In block 330, at step 335, it is determined, via reference to Fibre Channel processing layer 510, whether there is any data transmission occurring with respect to the local SAN site/link 105. One of two separate digital filter values is then calculated, one value, stored in buffer 504, when the network link is idle, at step 345, and one value, stored in buffer 503, when data transmission is occurring, at step 340. After a predetermined interval, indicated at step 350, the difference between the two filter values 503/504 is calculated to obtain the delta PING time, at step 360.

At step 365, the number of resources 203 associated with the resource computation module 202 (and corresponding storage device 210) is then either increased or decreased, as a function of the difference between the two PING filter values 503/504 (i.e., delta PING), and the system retry (transmission error) rate. FIGS. 4 and 6, described below, illustrate two possible methods that may be used to adjust the number of resources 203 made available to a particular storage device 210.

FIG. 4 is a flowchart showing an exemplary set of steps performed in step 360, in one embodiment of the present method shown in FIG. 3. As shown in FIG. 4, at step 405, if the delta PING time is less than a predetermined lower threshold value (e.g., 200 milliseconds), then, at step 410, a determination is made as to whether the number of transmission errors (if any) that have occurred between the local and remote SAN sites in the most recent ‘PING interval’ (the period of time determined by the PING rate) is less than a predetermined threshold value. The frequency of occurrence of these transmission errors is hereinafter termed the “message retry rate” (or simply, the “retry rate”). In an exemplary embodiment, this retry rate threshold is two retries per second. Resource computation module 202 communicates with Fibre Channel processing layer 510 (shown in FIG. 5) to determine whether transmission errors have occurred.

If the message retry rate is less than the threshold value in the most recent PING interval, the number of transmission resources 203 available for use by a particular storage device 210 is increased by a pre-determined value (e.g., one-half the initial resource value) up to the maximum number of resources allowed (e.g., 64), at step 415. Alternatively, rather than using a pre-established, fixed value, a dynamically determined resource ramp-up value can be determined, as described below with respect to FIG. 6.

If (at step 405), the delta PING time is greater than the lower threshold value, then at step 407, the transmission error rate is checked. If the transmission error rate is greater than the corresponding threshold, resources 203 are always decreased, regardless of the PING delta time, as indicated at step 420. If the transmission error rate is less than the threshold value, then a determination is made (at step 407) as to whether the delta PING time is greater than a predetermined upper threshold value (e.g., 650 milliseconds). If the delta PING time does not exceed the upper threshold value, then the number of transmission resources 203 available for use by the present storage device 210 is maintained at the current level, at step 408. Conversely, if the value of delta PING does exceed this upper threshold, then the number of resources 203 available for use by the storage device is decreased by a pre-determined value (e.g., 16), down to a predetermined minimum number of resources allowed (e.g., 12), at step 420. Alternatively, a dynamically determined ramp-down value can be used. If dynamically determined, the ramp-down rate at which the number of transmission resources 203 is decreased is described below in detail with respect to FIG. 6. Control flow then continues with step 365 in FIG. 3.

There are two, essentially asynchronous, functional loops performed as part of the process described above. As shown in FIG. 3, the loop consisting of steps 320 through 350 are performed by a given storage device 210 at a PING rate-determined frequency, for example, once per second. In an exemplary embodiment, the loop consisting of steps 360 through 365 is executed by a given storage device 210 at a relatively lower frequency, for example, every 10 seconds. Thus, in the presently-described embodiment, the ‘resource adjustment sampling rate’ (i.e., the step 360-365 loop) is not the same as the PING rate. The delay between successive resource adjustment determinations is a function of the time constant of digital filter 502.

The digital filter value calculations executed in accordance with the present method are performed by using the ‘I/O in progress’ and ‘system idle’ sample values at each PING rate-determined interval. The delta PING value is only calculated when needed in resource computation module 202 when it executes at its predetermined period (e.g., 10 to 12 seconds).

FIG. 6 is a flowchart showing an exemplary set of steps performed to dynamically determine the resource adjustment rate, rather than using only predetermined values. As indicated above, the number of transmission resources 203 is increased when the delta PING time and message retry rate are below certain threshold values. The rate of increase, or ramp-up rate, depends upon the value of the delta PING time and the maximum number of resources available. Conversely, the transmission resources 203 are reduced when the delta PING time or message retry rate is above threshold values.

As shown in FIG. 6, at step 605, the delta PING time is determined by comparator 501. If the delta PING time is less than or equal to a ‘lower limit’ threshold value, then, at step 610, the message retry (error) rate is checked to determine whether it is also less than a predetermined threshold value. In the presently-described embodiment, a typical delta PING lower limit threshold value is 200 milliseconds, and a typical message retry rate threshold is two retries per second. If the message retry rate is less than the threshold value, then the number of resources 203 utilized by a given storage device 210 is increased, or ‘ramped-up’ as a function of the total number of resources and the delta PING time, at step 615. Ramp-up rate determination is described further below.

If (at step 605), the delta PING time is greater than the lower threshold value, then at step 607, the transmission error rate is checked. If the transmission error rate is greater than the corresponding threshold, resources 203 are always decreased, regardless of the PING delta time, as indicated at step 620. If the transmission error rate is less than the threshold value, then a determination is made (at step 607) as to whether the delta PING time is greater than a predetermined upper threshold value. In an exemplary embodiment, a typical delta PING upper limit threshold is 650 milliseconds. If the delta PING time does not exceed the upper threshold value, then the number of transmission resources 203 available for use by the present storage device 210 is maintained at the current level, at step 608. Conversely, if the value of delta PING does exceed this upper threshold, then the number of resources 203 available for use by the storage device is decreased, or ramped-down, at step 620.

The transmission resource ramp-up rate is a function of factors including the total number of available resources and round-trip PING time. Resources 203 are increased at a faster rate for short PING times and at a slower rate for relatively longer PING times when the inter-SAN network link 105 is in use. In an exemplary embodiment, where a delta PING delay of one millisecond is experienced, the resources in use are increased by one-half of the total number of available resources 203, up to the maximum number of resources available. In the present embodiment, with a delta PING delay of 200 milliseconds, the resources in use are, for example, increased by one, up to a maximum number of 64.

The resource ramp-down rate is adjusted as a function of the same factors used to adjust the ramp-up rate, specifically, the delta PING time and the message retry rate. However, the rate of resource ramp-down, or decrease, is relatively faster than the rate of resource ramp-up, to more quickly reduce the congestion detected on the lower bandwidth path 105. This approach reduces the contention for resources 203 on the shared higher bandwidth path 115 and allows the overall throughput to increase more quickly.

In an exemplary embodiment, the ramp-up and ramp-down functions for a given storage device 210 comprise linear equations of the general form (y=mx+b). In the functions (FN1 and FN2) set forth below, the value of y indicates the number of resources 203 to either be added to or subtracted from the number of resources currently available for use by the storage device. The remaining terms (mx+b) are indicated in the functions.

In the two functions (FN1 and FN2) set forth below, “Max_Resources” is the maximum number of available resources 203 for a particular storage device 210, and the PING time threshold and delta PING are expressed in the same units of time. The term “Increase_Resources” represents the number of resources to add to the number currently available for use by the storage device 210. The term “lower limit threshold value” represents the delta PING time below which resources 203 are ramped up, if the transmission error rate is also below a threshold value.

The first function (FN1) set forth below is an example of a ramp-up function (shown in block 615 of FIG. 6):

FN1:

For delta PING<=(less than or equal to) lower limit threshold value:
Increase_Resources=(Max Resources/2)−(((Max_Resources/2)/lower limit threshold value)*delta PING)
Where delta PING>lower limit threshold value, Increase_Resources=0.

As an example, assume that Max_Resources is 64, and the lower limit threshold value=200 milliseconds. For a given value of delta PING, FN1 (above) is solved for Increase_Resources as follows:

$$\begin{matrix}Increase\_Resource = ( 64 / 2 ) - ( ( 64 / 2 ) / 200 ) * delta PING [ in milliseconds ] \\ = 32 - 0.16 * delta PING\end{matrix}$$

Given a delta PING equal to 100 milliseconds, the value for Increase_Resources in the above example reduces to:
32−(0.16*100)=(32−16)=16

Thus, for a storage device 210, with a maximum number of 64 available resources, with a lower limit threshold value of 200 milliseconds, and delta PING of 100 milliseconds, 16 resources are to be added to the number of resources currently available for a particular storage device 210 (up to the maximum of 64 available resources) in the present embodiment.

Function FN2 below is an example of a ramp-down function (shown in block 620 of FIG. 6). In function FN2, Decrease_Resources is the number of resources to be subtracted from the number of resources currently available for use by a storage device 210:

FN2:

For delta PING<=the lower limit threshold value:
Decrease_Resources=((Max_Resources/2)/lower limit threshold value)* delta PING
Where delta PING>lower limit threshold value, Decrease_Resources=32.

Certain changes may be made in the above methods and systems without departing from the scope of that which is described herein. It is to be noted that all matter contained in the above description or shown in the accompanying drawings is to be interpreted as illustrative and not in a limiting sense. For example, the system shown in FIG. 2, and the computation module of FIG. 5 may include components other than those shown therein, and the components may be arranged in other configurations. The elements and steps shown in FIGS. 3, 4, and 6 may also be modified in accordance with the methods described herein, and the steps shown therein may be sequenced in other configurations without departing from the spirit of the system thus described. The following claims are intended to cover all generic and specific features described herein, as well as all statements of the scope of the present method, system and structure, which, as a matter of language, might be said to fall therebetween.

What is claimed is:

1. A method for controlling data throughput in a network including a source site and a destination site interconnectable via a network link using an inter-site communication protocol different than an intra-site communication protocol used within the source site; wherein the source site includes a switch, a source storage device, and an intra-site link which shares data transmitted between the switch and the source storage device; and wherein the destination site includes a destination storage device for receiving data from the source storage device via the network link, the method comprising:
determining round trip PING times for each of a series of PING messages received from the destination storage device in response to corresponding PING messages sent by the source storage device, via the network link;
sorting the round trip PING times to separate idle PING timing data sampled when the network link was idle, from busy PING timing data sampled when the network link was in use;
calculating the difference between the sampled idle PING timing data and the sampled busy PING timing data to obtain a delta PING time; and
adjusting a number of transmission resources associated with the source storage device as a function of the value of the delta PING time and of a current inter-site transmission retry rate;
thereby reducing contention for said resources on the intra-site link.

2. The method of claim 1, wherein the resources include communication slots that are available to send messages from a source storage device via the intra-site link.

3. The method of claim 1, wherein the intra-site communication protocol operates essentially in accordance with the Fibre Channel specification.

4. The method of claim 1, wherein the number of said resources available for use by the source storage device is increased when the delta PING time and the retry rate are below a first pair of respective threshold values, and the number of said resources is decreased when either the delta PING time or the retry rate is above a second pair of respective threshold values.

5. The method of claim 4, wherein a resource ramp-up rate for the source storage device is adjusted dynamically as a function of round-trip PING time.

6. The method of claim 4, wherein the rate of increase of the number of resources and the rate of decrease of the number of resources is a function of the value of the delta PING time and the maximum number of resources available.

7. The method of claim 1, wherein the number of resources associated with the source storage device is adjusted by performing steps comprising:
if the delta PING time is less than a lower threshold value, then a determination is made as to whether the current retry rate is less than a rate threshold value;
if the retry rate is less than the rate threshold value, then the number of resources available for use by the source storage device is increased;
if the delta PING time is greater than the lower threshold value, then if the retry rate is greater than the rate threshold, the number of resources available for use by the source storage device is decreased;
if the retry rate is less than the rate threshold value, then if the delta PING time does not exceed an upper threshold value, the number of resources available for use by the source storage device is maintained at a current level; and
if the value of delta PING does exceed the upper threshold, then the number of resources available for use by the source storage device is decreased.

8. The method of claim 7, wherein the number of resources available for use by the source storage device is decreased and increased by corresponding pre-determined values.

9. The method of claim 8, wherein the number of resources available for use by the source storage device is adjusted by increasing the number of resources at a first rate for short PING times, and at a second rate, slower than the first rate, for relatively longer PING times when the network link is in use.

10. The method of claim 1, wherein the number of resources available for use by the source storage device is adjusted dynamically by performing steps comprising:
increasing the number of resources available for use by the source storage device at a first rate, if the value of delta PING is less than a lower threshold value, and the retry rate is less than a corresponding threshold value;
decreasing the number of resources available for use by the source storage device at a second rate, faster than the first rate, If either the inter-site transmission error rate is greater than a corresponding threshold, or if the value of delta PING exceeds an upper threshold value; and maintaining, at a current level, the number of resources available for use by the source storage device, if the delta PING time does not exceed the upper threshold value.

11. The method of claim 10, wherein the rate at which said resources are decreased is relatively faster than the rate at which said resources are increased.

12. The method of claim 1, wherein the inter-site communication protocol and the intra-site communication protocol are the same, and wherein the inter-site link has a lower bandwidth than the intra-site link.

13. A method for controlling data throughput in a network including a source site and a destination site interconnectable via a network link using an inter-site communication protocol; wherein the source site uses an intra-site communication protocol different than the inter-site communication protocol, and includes a server connected to a source storage device via a first intra-site link, a switch, and a second intra-site link which shares data transmitted between the switch and the source storage device; wherein the destination site includes a destination storage device for receiving data from the source storage device via the network link, the method comprising:
determining round trip PING times for each of a series of PING messages received from the destination storage device in response to corresponding PING messages sent by the source storage device, via the network link;
sorting the round trip PING times to separate idle PING timing data sampled when the network link was idle, from busy PING timing data sampled when the network link was in use; and
calculating the difference between the sampled idle PING timing data and the sampled busy PING timing data to obtain a delta PING time;
wherein a number of transmission resources associated with the source storage device is increased when the delta PING time and inter-site transmission message retry rate are below a first pair of respective threshold values, and the number of resources are decreased when either the delta PING time or the retry rate is above a second pair of respective threshold values.

14. The method of claim 13, wherein the inter-site communication protocol and the intra-site communication protocol are the same, and wherein the inter-site link has a lower bandwidth than the intra-site link.

15. A system for controlling data throughput in a network including a source site and a destination site interconnectable via a network link using an inter-site communication protocol different than an intra-site communication protocol used within the source site; wherein the source site includes a switch, a source storage device, and a intra-site link which shares data transmitted between the switch and the source storage device; and wherein the destination site includes a destination storage device for receiving data from the source storage device via the network link, the system comprising:
a timer that samples and records the round-trip time of a PING message sent from the source storage device to the destination storage device;
a digital filter, coupled to the timer, that sorts idle PING timing data sampled when the network link was idle from busy PING timing data sampled when the network link was in use;
first and second buffers, coupled to the digital filter, for respectively storing idle PING timing data and busy PING timing data;
a comparator, coupled to the first and second buffers, that calculates the difference between the sampled idle PING timing data and the sampled busy PING timing data to obtain a delta PING time; and
a resource adjustment module, coupled to the comparator;
wherein the resource adjustment module:
increases the number of transmission resources associated with the source storage device when the delta PING time and inter-site transmission retry rate are below a first pair of respective threshold values, and
decreases the number of said resources when either the delta PING time or the retry rate is above a second pair of respective threshold values.

16. The system of claim 15, wherein the number of said resources available for use by the source storage device is adjusted by:
increasing the number of said resources when the delta PING time and the retry rate are below corresponding threshold values; and
decreasing the number of said resources when either the delta PING time or the retry rate is above corresponding threshold values.

17. The system of claim 15, wherein said resources include communication slots that are available to send messages from a source storage device via the intra-site link.

18. The system of claim 15, wherein intra-site communication protocol operates essentially in accordance with the Fibre Channel specification.

19. The system of claim 15, wherein the number of resources available for use by the source storage device is increased when the delta PING time and the retry rate are below a first pair of respective threshold values, and the number of resources is decreased when either the delta PING time or the retry rate is above a second pair of respective threshold values.

20. The system of claim 19, wherein the rate of increase of the number of said resources and the rate of decrease of the number of said resources is a function of the value of the delta PING time and the maximum number of said resources available.

21. The system of claim 15, wherein a resource ramp-up rate for the source storage device is adjusted dynamically as a function of factors including the total number of available resources and round-trip PING time.

22. The system of claim 21, wherein the number of resources available for use by the source storage device is adjusted by increasing the number of said resources at a first rate for short PING times, and at a second rate, slower than the first rate, for relatively longer PING times when the network link is in use.

23. The system of claim 15, wherein the inter-site communication protocol and the intra-site communication protocol are the same, and wherein the inter-site link has a lower bandwidth than the intra-site link.

24. A system for controlling data throughput in a network including a source site and a destination site interconnectable via two gateways, each at opposite ends of a network link, using an inter-site communication protocol; wherein the source site uses an intra-site communication protocol different than the inter-site communication protocol, and includes a switch, a source storage device, and a intra-site link which shares data transmitted between the switch, the source storage device and one of the network gateways; wherein the destination site includes a destination storage device for receiving data from the source storage device via the network link, the system comprising:
means for determining round trip PING times for each of a series of PING messages received from the destination storage device in response to corresponding PING messages sent by the source storage device, via the network link;
means for sorting the round trip PING times to separate idle PING timing data sampled when the network link was idle from busy PING timing data sampled when the network link was in use;
means for calculating the difference between the sampled idle PING timing data and the sampled busy PING timing data to obtain a delta PING time; and
means for adjusting the number of resources associated with the resource computation module as a function of the value of the delta PING time and of the inter-site transmission error rate.
